(19) United States
(12) Patent Application Publication
(10) Pub. No.: US 2022/0228002 A1
(43) Pub. Date: Jul. 21, 2022

(54) SURFACE-COATED INORGANIC PARTICLES AND METHOD FOR MANUFACTURING SAME, AND ORGANIC SOLVENT DISPERSION CONTAINING SAME

(71) Applicant: ISHIHARA SANGYO KAISHA, LTD., Osaka (JP)

(72) Inventors: Hironori KATO, Osaka (JP); Tadahiko TAKIMOTO, Osaka (JP)

(21) Appl. No.: 17/611,951

(22) PCT Filed: Jun. 4, 2020
(86) PCT No.: PCT/JP2020/022070

§ 371 Date: Nov. 17, 2021

(30) Foreign Application Priority Data
Jun. 19, 2019 (JP) 2019-113604

(51) Int. Cl. C09C 1/36; C09D 7/62; C09D 201/00; C08K 9/04; C08K 3/22

(52) U.S. Cl. CPC C09C 1/3669; C09D 7/62; C08K 2003/2241; C08K 9/04; C08K 3/22; C09D 201/00

(57) ABSTRACT

Provided are surface-coated inorganic particles and a method for manufacturing the same, whereby the dispersibility of inorganic particles in an organic solvent can be improved, and a function or performance of the inorganic particles can thereby be adequately demonstrated. In the present invention, surfaces of inorganic particles of titanium oxide or the like are coated with a reaction product of a silicate compound having an amino group, and/or a hydrolysis product thereof, and at least one compound selected from the group consisting of a carboxylic acid, a carboxylic acid halide, an acid anhydride, a sulfonic acid halide, and an isocyanate. The reaction product forming the coating is preferably a silicate compound having at least one bond selected from the group consisting of an amide bond, a sulfonamide bond, a urethane bond, and a urea bond, and/or a hydrolysis product thereof.

### TECHNICAL FIELD

The present invention relates to surface-coated inorganic particles and a method for manufacturing the same, and an organic solvent dispersion containing the surface-coated inorganic particles and a method for manufacturing the same. The present invention further relates to a paint composition containing the surface-coated inorganic particles, and a method for manufacturing a surface-coated inorganic particle layer.

### BACKGROUND ART

Various inorganic particles, for example, particles of metal oxides, metal nitrides, and metals, are used in various applications such as pigments, ultraviolet ray shielding agents, infrared ray shielding agents, visible light transmitting agents, fillers, hard coating agents, and refractive index adjusters. In such cases, in order to improve the dispersibility in a dispersing medium or to improve functions such as shielding properties and transmissivity, the inorganic particles are surface-coated with an organic compound before use. For example, Patent Literature 1 discloses metal oxide core particles having a coating layer comprising the following materials: an inorganic material; and (i) a quaternary silane coupling agent, and/or (ii) a silane coupling agent and a hydrophobizing agent. Patent Literature 1 describes that an amino silane coupling agent is specifically used as the silane coupling agent to exhibit effective UV absorption properties, reduced photoactivity, and improved skin feel.

### CITATION LIST

### Patent Literature

PATENT LITERATURE 1: JP 2015-531734 A

### SUMMARY OF INVENTION

### Technical Problem

According to Patent Literature 1 above, the functions such as the dispersibility in a dispersing medium are improved because the metal oxide core particles have the coating layer comprising the amino silane coupling agent, but further improvement thereof is desired.

### Solution to Problem

The present inventors intensively studied to improve the dispersibility of inorganic particles coated with an organic compound in an organic solvent. As a result, the present inventors have found that desired results as the dispersibility in an organic solvent can be obtained by coating the surfaces of inorganic particles with a product obtained by reacting a silicate compound having an amino group with a specific compound, and thus have completed the present invention.

That is, the present invention is as follows, for example.

(1) Surface-coated inorganic particles coated with a reaction product of following compounds: a silicate compound having an amino group and/or a hydrolysis product of the silicate compound; and at least one compound selected from the group consisting of a carboxylic acid, a carboxylic acid halide, an acid anhydride, a sulfonic acid halide, and an isocyanate, on each surface of the inorganic particles.

(2) The surface-coated inorganic particles according to (1), wherein the reaction product is a silicate compound having at least one bond selected from the group consisting of an amide bond, a sulfonamide bond, a urethane bond, and a urea bond, and/or a hydrolysis product of the silicate compound.

(3) The surface-coated inorganic particles according to (1) or (2), wherein the reaction product is a silicate compound having 3 to 100 carbon atoms and/or a hydrolysis product of the silicate compound.

(4) The surface-coated inorganic particles according to any one of (1) to (3), wherein the inorganic particles are composed of inorganic core particles and an inorganic compound coating each surface of the inorganic core particles.

(5) The surface-coated inorganic particles according to any one of (1) to (4), wherein the inorganic particles or when the inorganic particles are composed of inorganic core particles and an inorganic compound coating each surface of the inorganic core particles, the inorganic core particles are titanium oxide particles.

(6) A surface-coated inorganic particle-containing organic solvent dispersion comprising the surface-coated inorganic particles according to any one of (1) to (5), which are dispersed in an organic solvent.

(7) The surface-coated inorganic particle-containing organic solvent dispersion according to (6), further comprising a polymer dispersing agent.

(8) A paint composition comprising:

the surface-coated inorganic particles according to any one of (1) to (5);

an organic solvent; and

a resin.

(9) A paint composition comprising:

the surface-coated inorganic particle-containing organic solvent dispersion according to (6) or (7); and

a resin.

(10) A method for manufacturing surface-coated inorganic particles, the method comprising the steps of:

mixing, in an aqueous solvent, inorganic particles with a silicate compound having an amino group and/or a hydrolysis product of the silicate compound, thereby coating each surface of the inorganic particles with the silicate compound having an amino group and/or a hydrolysis product of the silicate compound; and

subsequently suspending, in an organic solvent, the inorganic particles coated with the silicate compound having an amino group and/or a hydrolysis product of the silicate compound, and then mixing therewith at least one compound selected from the group consisting of a carboxylic acid, a carboxylic acid halide, an acid anhydride, a sulfonic acid halide, and an isocyanate, thereby coating each surface of the inorganic particles with a reaction product of the silicate compound having an amino group and/or a hydrolysis product of the silicate compound and the at least one compound.

(11) A method for manufacturing surface-coated inorganic particles, the method comprising the steps of:

performing the step as set forth in (10) of coating each surface of the inorganic particles with the silicate compound having an amino group and/or a hydrolysis product of the silicate compound, thereby obtaining an aqueous suspension containing the inorganic particles coated with the silicate compound having an amino group and/or a hydrolysis product of the silicate compound;

subsequently mixing the aqueous suspension with a surfactant, thereby transferring to an organic solvent the inorganic particles coated with the silicate compound having an amino group and/or a hydrolysis product of the silicate compound; and

subsequently mixing the inorganic particles transferred to the organic solvent with at least one compound selected from the group consisting of a carboxylic acid, a carboxylic acid halide, an acid anhydride, a sulfonic acid halide, and an isocyanate, thereby coating each surface of the inorganic particles with a reaction product of the silicate compound having an amino group and/or a hydrolysis product of the silicate compound and the at least one compound.

(12) A method for manufacturing surface-coated inorganic particles, the method comprising the steps of:

performing the step as set forth in (11) of mixing the aqueous suspension with a surfactant, thereby transferring to an organic solvent the inorganic particles coated with the silicate compound having an amino group and/or a hydrolysis product of the silicate compound;

subsequently subjecting the inorganic particles transferred to the organic solvent to a heat treatment at a temperature of 80 to 200° C.; and

subsequently mixing the inorganic particles subjected to the heat treatment with at least one compound selected from the group consisting of a carboxylic acid, a carboxylic acid halide, an acid anhydride, a sulfonic acid halide, and an isocyanate, thereby coating each surface of the inorganic particles with a reaction product of the silicate compound having an amino group and/or a hydrolysis product of the silicate compound and the at least one compound.

(13) A method for manufacturing surface-coated inorganic particles, the method comprising the step of:

performing the step as set forth in any one of (10) to (12) of coating each surface of the inorganic particles with a reaction product of the silicate compound having an amino group and/or a hydrolysis product of the silicate compound and the at least one compound, thereby obtaining an organic solvent in which the surface-coated inorganic particles are suspended; and

subsequently subjecting the organic solvent to solid-liquid separation, thereby recovering the surface-coated inorganic particles.

(14) A method for manufacturing a surface-coated inorganic particle-containing organic solvent dispersion, the method comprising the step of:

performing the step as set forth in (13) of recovering the surface-coated inorganic particles, thereby recovering the surface-coated inorganic particles; and

subsequently dispersing the recovered surface-coated inorganic particles in an organic solvent.

(15) A method for manufacturing a surface-coated inorganic particle layer, the method comprising:

applying or spraying on a substrate the surface-coated inorganic particle-containing organic solvent dispersion according to (6) or (7) or the paint composition according to (8) or (9).

### Advantageous Effects of Invention

According to the present invention, the dispersibility of inorganic particles in an organic solvent can sufficiently be improved, and thus function or performance of the inorganic particles can sufficiently be exhibited.

In addition, the surface-coated inorganic particles of the present invention can be manufactured by a simple method.

### DESCRIPTION OF EMBODIMENTS

The present invention relates to surface-coated inorganic particles coated with a reaction product of the following compounds: a silicate compound having an amino group and/or a hydrolysis product of the silicate compound; and at least one compound selected from the group consisting of a carboxylic acid, a carboxylic acid halide, an acid anhydride, a sulfonic acid halide, and an isocyanate, the reaction product on each surface of the inorganic particles.

The above inorganic particles are not particularly limited, and examples thereof include metal oxide particles such as those of zinc oxide, titanium oxide, zirconium oxide, tin oxide, cerium oxide, iron oxide, and silicon oxide; metal composite oxide particles such as those of barium titanate, strontium titanate, and calcium titanate; metal compound particles such as those of metal nitrides such as titanium nitride, titanium oxynitride, silicon nitride, silicon oxynitride, aluminum nitride, and aluminum oxynitride, and those of metal carbides such as titanium carbide, zirconium carbide, silicon carbide, and aluminum carbide; and metal particles such as those of metal copper, silver, and gold. The average particle diameter of the inorganic particles can appropriately be designed according to the application, and is preferably in the range of 1 nm to 50 μm, more preferably 2 nm to 5 μm, still more preferably 3 nm to 500 nm, and most preferably 3 nm to 100 nm. The average particle diameter is a numerical value obtained by measuring the longest straight line portions of 100 inorganic particles in an electron micrograph of the inorganic particles, and is one determined by the number average of the measured values.

The inorganic particles may be composed only of inorganic particles, and may be composed of inorganic core particles and an inorganic compound coating surfaces of the inorganic core particles. Examples of the inorganic core particles include the above inorganic particles such as those of titanium oxide, zinc oxide, silicon oxide, and aluminum oxide. It is preferred that surfaces of the inorganic core particles be coated with an inorganic compound such as an oxide or hydroxide of silicon, aluminum, tin, zinc, titanium, antimony, zirconium, or cobalt. The coating of the inorganic core particles with the inorganic compound means a state in which the inorganic compound is adsorbed to or precipitated on the surfaces of the inorganic core particles and is present on the surfaces of the inorganic core particles. The inorganic compound coating the inorganic core particles is required to be present on at least a part of each surface of the inorganic particles. The coating amount with the inorganic compound is preferably 0.1 to 50 parts by mass, more preferably 0.5 to 40 parts by mass, and still more preferably 1 to 30 parts by mass with respect to 100 parts by mass of the inorganic particles. It is preferred that the inorganic core particles be titanium oxide particles, and that the surfaces of the inorganic core particles be coated with an inorganic compound such as an oxide or hydroxide of silicon, aluminum, tin, zinc, titanium, antimony, zirconium, or cobalt, and such particles can be used as a titanium dioxide pigment, titanium oxide fine particles, or the like. When the particles are used as a titanium dioxide pigment, the average particle diameter of the particles is preferably 0.1 μm to 0.5 μm, more preferably 0.15 μm to 0.4 μm, and still more preferably 0.2 μm to 0.3 μm. When the particles are used as titanium oxide fine particles, the average particle diameter of the particles is preferably 1 nm to 100 nm, more preferably 2 nm to 80 nm, and still more preferably 3 nm to 50 nm.

The reaction product on each surface of the inorganic particles is a reaction product produced by reacting a silicate compound having an amino group and/or a hydrolysis product of the silicate compound with at least one compound selected from the group consisting of a carboxylic acid, a carboxylic acid halide, an acid anhydride, a sulfonic acid halide, and an isocyanate. Such a reaction product may be understood to be a silicate compound having at least one bond selected from the group consisting of an amide bond, a sulfonamide bond, a urethane bond, and a urea bond, which are as described later, and/or a hydrolysis product of the silicate compound (i.e., a compound having —C—Si—O—). Although it is possible to identify the structure of the reaction product by infrared spectroscopy or the like, but there may be a case where the structure cannot clearly be identified because the coating amount with the reaction product is very small. Therefore, in the present application, a compound as the reaction product on each surface of the inorganic particles is also referred to as a reaction product of the following compounds: a silicate compound having an amino group and/or a hydrolysis product of the silicate compound; and at least one compound selected from the group consisting of a carboxylic acid, a carboxylic acid halide, an acid anhydride, a sulfonic acid halide, and an isocyanate.

In the present application, “the reaction product coating each surface of the inorganic particles” or “coating each surface of the inorganic particles with the reaction product” means that the above reaction product is adsorbed to or precipitated on each surface of the inorganic particles or reacts on each surface of the inorganic particles, and is present in a state in which the above reaction product or a part thereof is deformed (e.g., the reaction product is present on each surface of the inorganic particles in a state in which the alkoxy group is decomposed and the alkyl group is separated (i.e., —Si—O—) or in a state in which the alkoxy group is hydrolyzed). The above reaction product is preferably a low-molecular silicate compound having 3 to 100 carbon atoms and/or a hydrolysis product of the silicate compound. The number of carbon atoms is more preferably 3 to 50, and still more preferably 3 to 40.

The above reaction product, specifically, the silicate compound having at least one bond selected from the group consisting of an amide bond, a sulfonamide bond, a urethane bond, and a urea bond, and/or a hydrolysis product of the silicate compound is required to be present on at least a part of each surface of the inorganic particles. In order to sufficiently disperse the inorganic particles in an organic solvent, it is preferred that the reaction product coat the inorganic particles as densely as possible. The coating amount with the reaction product is preferably 0.1 to 50 parts by mass, more preferably 0.5 to 40 parts by mass, and still more preferably 1 to 30 parts by mass with respect to 100 parts by mass of the inorganic particles.

The amide bond which the reaction product coating each surface of the inorganic particles has means a bond between a carbonyl group and a nitrogen atom (i.e., ═N—(C═O)—). Examples of the silicate compound having an amide bond include compounds (a) and (b) shown in the following: (a) a silicate compound having an amide group at an end of a chemical structural formula (e.g., (NH₂—C(═O)—R—Si) and (NH₂—C(═O)—Si)); and (b) a silicate compound having an amide bond in the middle of a chemical structural formula (e.g., (R—C(═O)NH—R′—Si), (R—C(═O)NH—Si), and (R—NH—C(═O)NH—R′—Si)).

Specific examples of the compound (b) include a compound represented by “Formula (1)”, which is more preferred because sufficient dispersibility in an organic solvent can be secured.

R¹—C(═O)N(—R²)R³—Si(OR⁴)ₐR⁵₃₋ₐ (1)

(In “Formula (1)”, “R¹” represents a linear or branched alkyl group having 1 to 30 carbon atoms, a linear or branched alkenyl group having 2 to 30 carbon atoms, a linear or branched alkynyl group having 2 to 30 carbon atoms, a cycloalkyl group having 3 to 30 carbon atoms, a cycloalkenyl group having 3 to 30 carbon atoms, a cycloalkynyl group having 3 to 30 carbon atoms, an aralkyl group having 7 to 30 carbon atoms, or an aryl group having 6 to 30 carbon atoms, and “R²” represents a hydrogen atom, a linear or branched alkyl group having 1 to 30 carbon atoms, a cycloalkyl group having 3 to 30 carbon atoms, a cycloalkenyl group having 3 to 30 carbon atoms, a cycloalkynyl group having 3 to 30 carbon atoms, or a heterocyclic group having 3 to 30 carbon atoms. “R³” represents a linear or branched alkylene group having 1 to 30 carbon atoms, a linear or branched alkenylene group having 2 to 30 carbon atoms, or a linear or branched alkynylene group having 2 to 30 carbon atoms. Each “R⁴” independently represents a hydrogen atom, a linear or branched alkyl group having 1 to 30 carbon atoms, a linear or branched alkenyl group having 2 to 30 carbon atoms, or a linear or branched alkynyl group having 2 to 30 carbon atoms, and each “R⁵” independently represents a hydrogen atom, a hydroxyl group, a linear or branched alkyl group having 1 to 30 carbon atoms, a linear or branched alkenyl group having 2 to 30 carbon atoms, or a linear or branched alkynyl group having 2 to 30 carbon atoms. “a” is an integer of 1 to 3.)

In the present application, a heterocyclic ring is a saturated or unsaturated ring containing a heteroatom.

As for “Formula (1)”, “Formula (1′)” shown in the following is more preferred.

R¹—C(═O)N(—H)R³—Si(OR⁴)₃ (1′)

(In “Formula (1′)”, “R¹”, “R³”, and “R⁴” have the same definitions as those in “Formula (1)”. In “Formula (1′)”, it is preferred that “R¹” be a linear or branched alkyl group having 1 to 30 carbon atoms, a linear or branched alkenyl group having 2 to 30 carbon atoms, or a linear or branched alkynyl group having 2 to 30 carbon atoms, and it is preferred that each “R⁴” independently be a linear or branched alkyl group having 1 to 30 carbon atoms, a linear or branched alkenyl group having 2 to 30 carbon atoms, or a linear or branched alkynyl group having 2 to 30 carbon atoms.)

The sulfonamide bond of the reaction product coating each surface of the inorganic particles means a bond between a sulfonyl group and a nitrogen atom (i.e., ═N—(S═O₂)—). Examples of the silicate compound having a sulfonamide bond include compounds (a) and (b) shown in the following: (a) a silicate compound having a sulfonamide group at an end of a chemical structural formula (e.g., (NH₂—SO₂—R—Si)); and (b) a silicate compound having a sulfonamide bond in the middle of a chemical structural formula (e.g., (R—SO₂—NH—R′—Si)).

Specific examples of the compound (b) include a compound represented by “Formula (2)”.

R⁶—S(═O₂)N(—R⁷)R⁸—Si(OR⁹)_{b}R¹⁰_{3-b} (2)

(In “Formula (2)”, “R⁶” represents a linear or branched alkyl group having 1 to 30 carbon atoms, a linear or branched alkenyl group having 2 to 30 carbon atoms, a linear or branched alkynyl group having 2 to 30 carbon atoms, a cycloalkyl group having 3 to 30 carbon atoms, a cycloalkenyl group having 3 to 30 carbon atoms, a cycloalkynyl group having 3 to 30 carbon atoms, an aralkyl group having 7 to 30 carbon atoms, or an aryl group having 6 to 30 carbon atoms, and “R⁷” represents a hydrogen atom, a linear or branched alkyl group having 1 to 30 carbon atoms, a linear or branched alkenyl group having 2 to 30 carbon atoms, a linear or branched alkynyl group having 2 to 30 carbon atoms, a cycloalkyl group having 3 to 30 carbon atoms, a cycloalkenyl group having 3 to 30 carbon atoms, a cycloalkynyl group having 3 to 30 carbon atoms, or a heterocyclic group having 3 to 30 carbon atoms. “R⁸” represents a linear or branched alkylene group having 1 to 30 carbon atoms, a linear or branched alkenylene group having 2 to 30 carbon atoms, or a linear or branched alkynylene group having 2 to 30 carbon atoms. Each “R⁹” independently represents a hydrogen atom, a linear or branched alkyl group having 1 to 30 carbon atoms, a linear or branched alkenyl group having 2 to 30 carbon atoms, or a linear or branched alkynyl group having 2 to 30 carbon atoms, and each “R¹⁰” independently represents a hydrogen atom, a hydroxyl group, a linear or branched alkyl group having 1 to 30 carbon atoms, a linear or branched alkenyl group having 2 to 30 carbon atoms, or a linear or branched alkynyl group having 2 to 30 carbon atoms. “b” is an integer of 1 to 3.)

As for “Formula (2)”, “Formula (2′)” shown in the following is more preferred.

R⁶—S(═O₂)N(—H)R⁸—Si(OR⁹)₃ (2′)

(In “Formula (2′)”, “R⁶”, “R⁸”, and “R⁹” have the same definitions as those in “Formula (2)”. In “Formula (2′)”, it is preferred that “R⁶” be a linear or branched alkyl group having 1 to 30 carbon atoms, a linear or branched alkenyl group having 2 to 30 carbon atoms, or a linear or branched alkynyl group having 2 to 30 carbon atoms, and it is preferred that each “R⁹” independently be a linear or branched alkyl group having 1 to 30 carbon atoms, a linear or branched alkenyl group having 2 to 30 carbon atoms, or a linear or branched alkynyl group having 2 to 30 carbon atoms.)

The urethane bond of the reaction product coating each surface of the inorganic particles means a bond among a carbonyl group, a nitrogen atom, and an oxygen atom (i.e., ═N—(C═O)—O—). Examples of the silicate compound having a urethane bond include compounds (a) and (b) shown in the following: (a) a silicate compound having a urethane bond at an end of a chemical structural formula (e.g., (NH₂—C(═O)—O—R—Si) and (NH₂—C(═O)—O—Si)); and (b) a silicate compound having a urethane bond in the middle of a chemical structural formula (e.g., (R—O—C(═O)NH—R′—Si), (R—O—C(═O)NH—Si), and (R²—N—C(═O)—O—R′—Si)).

The urea bond of the reaction product coating each surface of the inorganic particles means a bond among a carbonyl group, a nitrogen atom, and a nitrogen atom (i.e., ═N—(C═O)—N═). Examples of the silicate compound having a urea bond include compounds (a) and (b) shown in the following: (a) a silicate compound having a urea bond at an end of a chemical structural formula (e.g., (NH₂—C(═O)—NH—R—Si) and (NH₂—C(═O)—NH—Si)); and (b) a silicate compound having a urea bond in the middle of a chemical structural formula (e.g., (R²—N—C(═O)NH—R′—Si), (R²—N—C(═O)NH—Si), and (R²—N—C(═O)NH—R′—Si)).

Specific examples of the compound (b) include a compound represented by “Formula (3)”, and examples thereof include ureidopropyltrimethoxysilane, ureidopropyltriethoxysilane, ureidopropylmethyldimethoxysilane, and ureidopropylmethyldiethoxysilane.

R¹¹—NR¹²C(═O)N(—R¹³)R¹⁴—Si(OR¹⁵)_{c}R¹⁶_{3-c} (3)

(In “Formula (3)”, “R¹¹” represents a linear or branched alkyl group having 1 to 30 carbon atoms, a linear or branched alkenyl group having 2 to 30 carbon atoms, a linear or branched alkynyl group having 2 to 30 carbon atoms, a cycloalkyl group having 3 to 30 carbon atoms, a cycloalkenyl group having 3 to 30 carbon atoms, a cycloalkynyl group having 3 to 30 carbon atoms, an aralkyl group having 7 to 30 carbon atoms, or an aryl group having 6 to 30 carbon atoms, and each of “R¹²” and “R¹³” independently represents a hydrogen atom, a linear or branched alkyl group having 1 to 30 carbon atoms, a linear or branched alkenyl group having 2 to 30 carbon atoms, a linear or branched alkynyl group having 2 to 30 carbon atoms, a cycloalkyl group having 3 to 30 carbon atoms, a cycloalkenyl group having 3 to 30 carbon atoms, a cycloalkynyl group having 3 to 30 carbon atoms, or a heterocyclic group having 3 to 30 carbon atoms. “R¹⁴” represents a linear or branched alkylene group having 1 to 30 carbon atoms, a linear or branched alkenylene group having 2 to 30 carbon atoms, or a linear or branched alkynylene group having 2 to 30 carbon atoms. Each “R¹⁵” independently represents a hydrogen atom, a linear or branched alkyl group having 1 to 30 carbon atoms, a linear or branched alkenyl group having 2 to 30 carbon atoms, or a linear or branched alkynyl group having 2 to 30 carbon atoms, and each “R¹⁶” independently represents a hydrogen atom, a linear or branched alkyl group having 1 to 30 carbon atoms, a linear or branched alkenyl group having 2 to 30 carbon atoms, or a linear or branched alkynyl group having 2 to 30 carbon atoms. “c” is an integer of 1 to 3.)

As for “Formula (3)”, “Formula (3′)” shown in the following is more preferred.

R¹¹—N(—H)C(═O)N(—H)R¹⁴—Si(OR¹⁵)₃ (3′)

(In “Formula (3′)”, “R¹¹”, “R¹⁴”, and “R¹⁵” have the same definitions as those in “Formula (3)”. In “Formula (3′)”, it is preferred that “R¹¹” be a linear or branched alkyl group having 1 to 30 carbon atoms, a linear or branched alkenyl group having 2 to 30 carbon atoms, or a linear or branched alkynyl group having 2 to 30 carbon atoms, and it is preferred that each “R¹⁵” independently be a linear or branched alkyl group having 1 to 30 carbon atoms, a linear or branched alkenyl group having 2 to 30 carbon atoms, or a linear or branched alkynyl group having 2 to 30 carbon atoms.)

Next, a dispersion dispersing at least the above surface-coated inorganic particles in an organic solvent will be described. The organic solvent can appropriately be selected. Specifically, at least one solvent selected from the following solvents can be used: hydrocarbon solvents such as toluene, xylene, solvent naphtha, normal hexane, isohexane, cyclohexane, methylcyclohexane, normal heptane, tridecane, tetradecane, and pentadecane; alcohol solvents such as methanol, ethanol, butanol, IPA (isopropyl alcohol), normal propyl alcohol, 2-butanol, TBA (tertiary butanol), butanediol, ethylhexanol, and benzyl alcohol; ketone solvents such as acetone, methyl ethyl ketone, methyl isobutyl ketone, DIBK (diisobutyl ketone), cyclohexanone, and DAA (diacetone alcohol); ester solvents such as ethyl acetate, butyl acetate, methoxybutyl acetate, cellosolve acetate, amyl acetate, normal propyl acetate, isopropyl acetate, methyl lactate, ethyl lactate, and butyl lactate; ether solvents such as methyl cellosolve, cellosolve, butyl cellosolve, dioxane, MTBE (methyl tertiary butyl ether), and butyl carbitol; glycol solvents such as ethylene glycol, diethylene glycol, triethylene glycol, and propylene glycol; glycol ether solvents such as diethylene glycol monomethyl ether, triethylene glycol monomethyl ether, propylene glycol monomethyl ether, and 3-methoxy-3-methyl-1-butanol; glycol ester solvents such as ethylene glycol monomethyl ether acetate, PMA (propylene glycol monomethyl ether acetate), diethylene glycol monobutyl ether acetate, and diethylene glycol monoethyl ether acetate; and amide solvents such as DMF (dimethylformamide), DEF (diethylformamide), DMAc (dimethylacetamide), and NMP (N-methylpyrrolidone). The content of the surface-coated inorganic particles is preferably 0.1 to 95 parts by mass, more preferably 10 to 90 parts by mass, and still more preferably 15 to 90 parts by mass with respect to 100 parts by mass of the organic solvent. The further blending of a polymer dispersing agent in the above organic solvent dispersion is more preferably because the dispersibility of the surface-coated inorganic particles can more sufficiently be maintained. The polymer dispersing agent may be a polymer of a single kind of monomer (i.e., a homopolymer), or may be a copolymer of two or more kinds of monomers. The polymer dispersing agent may be any of a random copolymer, a block copolymer, and a graft copolymer. When the polymer dispersing agent is a graft copolymer, the graft copolymer may be a comb-shaped graft copolymer or a star-shaped graft copolymer. The polymer dispersing agent may be, for example, an acrylic resin, a polyester resin, a polyurethane resin, a polyamide resin, a polyether, a phenol resin, a silicone resin, a polyurea resin, an amino resin, a polyamine such as polyethyleneimine or polyallylamine, an epoxy resin, or a polyimide. The polymer dispersing agent is adsorbed to the surface-coated inorganic particles via a functional group of the reaction product coating each surface of the inorganic particles, particularly a functional group of an amide-based silicate compound, and the surface-coated inorganic particles are dispersed in the organic solvent due to electrostatic repulsion and/or steric repulsion between the polymer dispersing agents. The polymer dispersing agent is preferably bonded to the surfaces of the surface-coated inorganic particles and adsorbed to the surface-coated inorganic particles as described above, and may be liberated in the organic solvent.

The polymer dispersing agent is more preferably a polymer compound having at least one basic functional group, and has a function of dispersing the surface-coated inorganic particles. Examples of the basic functional group include primary, secondary, and tertiary amino groups, ammonium groups, imino groups, and nitrogen-containing heterocyclic groups such as pyridine, pyrimidine, pyrazine, imidazole, and triazole. It is more preferred that the basic functional group have a base value in terms of amine value of 5 mgKOH/g or more. The lower limit of the amine value of the polymer dispersing agent is preferably 10 mgKOH/g or more, more preferably 15 mgKOH/g or more, still more preferably 20 mgKOH/g or more, and even more preferably 25 mgKOH/g or more. When the amine value is 5 mgKOH/g or more, sufficient dispersibility of the inorganic particles is easily achieved. The upper limit of the amine value of the polymer dispersing agent is preferably 150 mgKOH/g or less, more preferably 100 mgKOH/g or less, still more preferably 90 mgKOH/g or less, and particularly preferably 50 mgKOH/g or less. When the amine value is 150 mgKOH/g or less, the dispersion has not so strong basicity. From the viewpoint of pursuing better dispersibility, the amine value is particularly preferably in the range of 25 to 45 mgKOH/g.

The amine value of the polymer dispersing agent can be measured by a method in accordance with ASTM D 2074. Specifically, 5 g of the polymer dispersing agent and several drops of a bromocresol green ethanol solution are dissolved in 300 mL of a mixed solvent of ethanol and pure water, and then a 0.1 M solution of HCl in ethanol, of which a factor (specifically, a correction factor) is calculated, is added thereto. The amine value is calculated from the titration volume of the dropped 0.1 M solution of HCl in ethanol when the bromocresol green indicator has continuously exhibited yellow color for 30 seconds.

The polymer dispersing agent may have, in addition to the basic functional group, other functional groups. Examples of such other functional groups include one or more of functional groups selected from the group consisting of acidic functional groups and nonionic functional groups. Examples of the acidic functional group include a carboxyl group (—COOH), a sulfo group (—SO₃H), a sulfate group (—OSO₃H), a phosphonate group (—PO(OH)₃), a phosphate group (—OPO(OH)₃), a phosphinate group (—PO(OH)—), and a mercapto group (—SH). Examples of the nonionic functional group include a hydroxy group, an ether group, a thioether group, a sulfinyl group (—SO—), a sulfonyl group (—SO₂—), a carbonyl group, a formyl group, an ester group, a carbonic acid ester group, an amide group, a carbamoyl group, a ureido group, a thioamide group, a thioureido group, a sulfamoyl group, a cyano group, an alkenyl group, an alkynyl group, a phosphine oxide group, and a phosphine sulfide group.

The polymer dispersing agent having an acidic functional group in addition to a basic functional group has an acid value in addition to the amine value. The acid value of the polymer dispersing agent having an acidic functional group is preferably 50 mgKOH/g or less. The upper limit of the acid value of the polymer dispersing agent is more preferably 45 mgKOH/g or less, still more preferably 35 mgKOH/g or less, particularly preferably 30 mgKOH/g or less, and particularly more preferably 24 mgKOH/g or less. When the acid value is 50 mgKOH/g or less, the storage ability of the inorganic particles hardly deteriorates.

The acid value of the polymer dispersing agent can be measured in accordance with JIS 0070:1992. In 300 ml of pure water, 5 g of the polymer dispersing agent and several drops of a phenolphthalein solution are dissolved, and then a 0.1 M solution of KOH in ethanol, of which a factor (specifically, a correction factor) is calculated, is added thereto. The acid value is calculated from the titration volume of the dropped 0.1 M solution of KOH in ethanol when the phenolphthalein indicator has continuously exhibited pale red color for 30 seconds.

Specifically, the polymer dispersing agent having a basic functional group may be at least one of the following polymer dispersing agents: Solsperse (registered trademark) series 12000, 20000, 32550, 34750, 54000, 71000, and 74000 (manufactured by Lubrizol Japan Limited, basic functional group-containing copolymer); BYK (Disperbyk) (registered trademark) series 101, 108, 161, 162, 163, 164, 165, 166, 170, and SYNERGIST (registered trademark) 2100 (all manufactured by BYK Japan KK, organic group, block copolymer); JONCRYL (registered trademark) series 67, 678, 586, 611, 680, 682, 683, 690, and HPD-671 (all manufactured by Johnson Polymer Corporation, ester group, styrene-acrylic copolymer); S-LEC (registered trademark) series BL-1, BL-10, BM-1, and BM-2 (all manufactured by SEKISUI CHEMICAL CO., LTD., hydroxyl group, butyral resin); and AJISPER (registered trademark) series PB-711, PB-821, and PB-822 (all manufactured by Ajinomoto Fine-Techno Co., Inc., basic functional group-containing copolymer). Preferably, the polymer dispersing agent having a basic functional group is Solsperse (registered trademark) series 12000, 20000, 32550, or 34750, Bisperbyk-161, BYK-SYNERGIST (registered trademark) 2100, or S-LEC (registered trademark) BL-1 or BL-10.

From the viewpoint of dispersibility of the inorganic particles, the content of the polymer dispersing agent may be 0.5 parts by mass or more, 2 parts by mass or more, or 5 parts by mass or more with respect to 100 parts by mass of the inorganic particles. From the viewpoint of coating film strength, the content of the polymer dispersing agent may be 50 parts by mass or less, 30 parts by mass or less, or 10 parts by mass or less with respect to 100 parts by mass of the inorganic particles.

From the viewpoint of satisfactorily dispersing the inorganic particles, the weight average molecular weight of the polymer dispersing agent may be 750 or more, 1,000 or more, 2,000 or more, or 3,000 or more. From the viewpoint of well dispersing the inorganic particles, the weight average molecular weight of the polymer dispersing agent may be 100,000 or less, 50,000 or less, or 30,000 or less. The weight average molecular weight is a weight average molecular weight in terms of polystyrene, measured by GPC (i.e., gel permeation chromatography).

Next, a paint composition including at least the above surface-coated inorganic particles, an organic solvent, and a resin, and a paint composition including at least the above dispersion and a resin will be described. As for the organic solvent, those described above can be used. As for the resin, any resin can be used. For example, various types of resin such as a type of resin dissolving in a low polarity nonaqueous solvent, an emulsion type resin, and a colloidal dispersion type resin can be used without limitation. Examples of the resin include the following resins: a polyester resin; various modified polyester resins such as urethane-modified polyester resins, epoxy-modified polyester resins, and acrylic-modified polyesters; a polyether urethane resin; a polycarbonate urethane resin; a vinyl chloride-vinyl acetate copolymer; an epoxy resin; a phenol resin; an acrylic resin; a polyamideimide; a polyimide; modified celluloses such as an ethylcellulose, a hydroxyethylcellulose, a nitrocellulose, a cellulose acetate butyrate (CAB), and a cellulose acetate propionate (CAP); polyethylene glycol; and polyethylene oxide. The blending amount of the resin with respect to 100 parts by weight of the surface-coated inorganic particles is preferably in the range of about 0.5 to 100 parts by mass, more preferably in the range of about 1 to 50 parts by mass, and still more preferably in the range of about 2 to 25 parts by mass.

Specific examples include ARONIX (registered trademark) series B-309, B-310, M-430, M-406, M-460, and M-1100 (manufactured by TOAGOSEI CO., LTD.), LIGHT ACRYLATE (registered trademark) series MTG-A, DPM-A, THF-A, IB-XA, HOA-HH(N), 1,6HX-A, 1,9ND-A, PE-3A, and PE-4A (manufactured by kyoeisha Chemical Co., Ltd.), EPOLIGHT (trade name) series 40E, 4000, and 3002(N) (manufactured by kyoeisha Chemical Co., Ltd.), NK Ester (registered trademark) series A-TMM-3, A-9550, and A-DPH (manufactured by SHIN-NAKAMURA CHEMICAL Co., Ltd.), and KAYARAD (registered trademark) series DPHA, DPEA-12, and DPCA-60 (manufactured by Nippon Kayaku Co., Ltd.).

The above dispersion or paint composition can be applied or sprayed on a substrate to form a layer of the surface-coated inorganic particles, and the layer can also be cured as necessary. When titanium oxide fine particles are used as the surface-coated inorganic particles, a titanium oxide layer having high hardness and high visible light transmittance can be formed, and the titanium oxide layer can be used as a hard coat, a high refractive index layer, or an ultraviolet ray shielding layer. The substrate is not particularly limited, and glass, plastic, ceramic, metal, or the like can be used. The film thickness and the like can appropriately be set.

The surface-coated inorganic particles can be manufactured by obtaining a reaction product by reacting, in the presence of inorganic particles, preferably in an aqueous suspension containing inorganic particles, a silicate compound having an amino group and/or a hydrolysis product of the silicate compound with at least one compound selected from the group consisting of a carboxylic acid, a carboxylic acid halide, an acid anhydride, a sulfonic acid halide, and an isocyanate, thereby coating each surface of the inorganic particles with the reaction product. The manufacturing method preferably includes the following steps.

(A) In a step of coating each surface of the above inorganic particles with a silicate compound having an amino group and/or a hydrolysis product of the silicate compound, the silicate compound having an amino group and/or a hydrolysis product thereof is mixed with the aqueous suspension containing the inorganic particles. Examples of the silicate compound having an amino group include a compound represented by “Formula (I)” shown in the following:

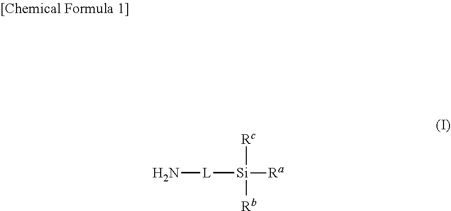

(wherein each of “R^{a}”, “R^{b}”, and “R^{c}” is independently a hydrogen atom, a hydroxyl group, an alkyl group, an alkenyl group, an alkynyl group, an alkoxy group, an alkenyloxy group, or an alkynyloxy group; and “L” is an alkylene group, an alkynylene group, an alkenylene group, or an alkyleneaminoalkylene group.)

The alkyl moiety in the alkyl group, alkoxy group, alkylene group, or alkyleneaminoalkylene group in “Formula (I)” is desirably a linear or branched group having 1 to 30 carbon atoms, and is more desirably a linear or branched group having 1 to 6 carbon atoms such as methyl, ethyl, normal propyl, isopropyl, normal butyl, isobutyl, secondary butyl, tertiary butyl, normal pentyl, isopentyl, neopentyl, normal hexyl, or neohexyl. The alkenyl moiety in the alkenyl group, alkenyloxy group, or alkenylene group in “Formula (I)” is desirably a linear or branched group having 2 to 30 carbon atoms, and is more desirably a linear or branched group having 2 to 6 carbon atoms such as vinyl, 1-propenyl, 2-propenyl, isopropenyl, 2-methyl-1-propenyl, 1-methyl-1-propenyl, 2-methyl-2-propenyl, 1-methyl-2-propenyl, 1-butenyl, 2-butenyl, 3-butenyl, 1-pentenyl, 2-pentenyl, 2-methyl-2-butenyl, 1-hexenyl, or 2,3-dimethyl-2-butenyl. The alkynyl moiety in the alkynyl group, alkynyloxy group, or alkynylene group in “Formula (I)” is desirably a linear or branched group having 2 to 30 carbon atoms, and is more desirably a linear or branched group having 2 to 6 carbon atoms such as ethynyl, 1-propynyl, 2-propynyl, 1-butynyl, 2-butynyl, 3-butynyl, 1-methyl-2-propynyl, 2-methyl-3-butynyl, 3,3-dimethyl-1-butynyl, 1-hexynyl, 2-hexynyl, 3-hexynyl, 4-hexynyl, or 5-hexynyl.

Specific examples of the silicate compound include a silanol compound in which in “Formula (I)”, “R^{a}”, “R^{b}”, and “R^{c}” are all hydroxyl groups, that is, a silanol compound having a partial structure of —C—Si(OH)₃, an alkoxysilane compound in which in “Formula (I)”, “R^{a}”, “R^{b}”, and “R^{c}” are all alkoxy groups, that is, an alkoxysilane compound having a partial structure of —C—Si(OR)₃, and an alkylalkoxysilane compound in which in “Formula (I)”, at least one of “R^{a}”, “R^{b}”, and “R^{c}” is an alkoxy group, and at least one of the remaining substituents is an alkyl group, that is, an alkylalkoxysilane compound having a partial structure of —C—Si(OR)ₓR′_{3-X} (“x” is an integer of 1 to 3). Compounds including a hydrolyzable group such as a hydroxyl group or an alkoxy group are more preferred. Specific examples of an amino group-containing alkoxysilane include 3-aminopropyltrimethoxysilane, 3-aminopropyltriethoxysilane, 3-aminopropylmethyldimethoxysilane, 3-aminopropylmethyldiethoxysilane, N-(2-aminoethyl)-3-aminopropyltrimethoxysilane, N-(2-aminoethyl)-3-aminopropyltriethoxysilane, N-(2-aminoethyl)-3-aminopropylmethyldimethoxysilane, and N-(2-aminoethyl)-3-aminopropylmethyldiethoxysilane. Hydrolysis products of these compounds can also be prepared and used.

First, the inorganic particles are mixed with the silicate compound having an amino group and/or a hydrolysis product of the silicate compound in an aqueous solvent so that the above silicate compound having an amino group and/or a hydrolysis product thereof can be adsorbed to, precipitated on, or reacted on each surface of the inorganic particles, thereby coating each surface of the inorganic particles. If necessary, the adjustment of the pH or the hydrolyzation of the silicate compound may be performed. The aqueous solvent may include water or an organic solvent soluble in water. In the mixing of the inorganic particles with a silicate compound having an amino group and/or a hydrolysis product of the silicate compound in the aqueous solvent, it is preferred to prepare a suspension liquid in which the inorganic particles are suspended or dispersed by means of an ordinary suspending machine or dispersing machine. Also, the inorganic particles may previously be suspended in the aqueous solvent by means of an ordinary suspending machine or dispersing machine, and then can mix a silicate compound having an amino group and/or a hydrolysis product of the silicate compound with the aqueous suspension. The content of the inorganic particles in the aqueous solvent can appropriately be set.

(B) Next, the aqueous suspension in step (A) is substituted with an organic solvent, and the above inorganic particles are suspended or dispersed in the organic solvent. The substitution method can be a conventionally known method such as centrifugation, decantation, or flushing. As a preferred method, a surfactant is mixed with the above aqueous suspension containing the inorganic particles coated with a silicate compound having an amino group and/or a hydrolysis product of the silicate compound to aggregate the inorganic particles, and then the inorganic particles are transferred to the organic solvent. The surfactant is preferably an anionic surfactant. Upon being dissociated in water, the anionic surfactant turns into anions, and neutralizes the silicate compound having an amino group and/or a hydrolysis product thereof applied to the inorganic particles in step (A), thereby aggregating and precipitating the inorganic particles. Examples of the surfactant include monoalkyl sulfates (ROSO₃⁻M⁺), alkyl polyoxyethylene sulfates (RO(CH₂CH₂O)ₘSO₃⁻M⁺), alkylbenzene sulfonates (RR′CH₂CHC₆H₄SO₃⁻M⁺), and monoalkyl phosphates (ROPO(OH)O⁻M⁺), and dialkyl sulfosuccinates such as dioctyl sodium sulfosuccinate and di(2-ethylhexyl) sodium sulfosuccinate are preferred. “R” represents an alkyl chain having 12 to 15 carbon atoms, “m” is an integer of 1 to 150, and “M” is an alkali metal. In order to transfer the inorganic particles to the organic solvent after mixing the surfactant, a known method can be used, such as a method of subjecting the aqueous suspension to solid-liquid separation and redispersing the inorganic particles in the organic solvent, a method of continuously subjecting the aqueous suspension to solvent substitution by ultrafiltration or the like, or a method of flushing with an organic solvent. As for the solid-liquid separation, a conventionally known method such as centrifugation, filtration, or ultrafiltration can be used, and the excessive silicate compound, surfactant, and the like can be removed. The inorganic particles may be washed as necessary. Furthermore, heat-treating (specifically, drying) the inorganic particles at a temperature of 80 to 200° C. is more preferred because each surface of the inorganic particles is more firmly coated with a silicate compound having an amino group and/or a hydrolysis product of the silicate compound. A more preferred temperature is 100 to 160° C. The inorganic particles to be heat-treated may be particles recovered by solid-liquid separation, particles in the state of the aqueous suspension, or particles transferred to the organic solvent.

Then, the inorganic particles transferred to the organic solvent or the inorganic particles subjected to the heat treatment are preferably suspended or dispersed in the organic solvent using a suspending machine or a dispersing machine to form a suspension liquid. The content of the inorganic particles can appropriately be set. The organic solvent preferably does not contain water, and the content of water is preferably 1% by mass or less.

(C) Next, in the step of coating each surface of the inorganic particles with a reaction product, the inorganic particles coated with a silicate compound having an amino group and/or a hydrolysis product of the silicate compound, as described above are mixed with at least one compound selected from the group consisting of a carboxylic acid, a carboxylic acid halide, an acid anhydride, a sulfonic acid halide, and an isocyanate, thereby coating each surface of the inorganic particles with a reaction product of the following compounds: the silicate compound having an amino group and/or a hydrolysis product thereof; and at least one compound described above. In the above mixture of at least one compound described above, it is preferred to use the suspension liquid obtained by suspending or dispersing the above inorganic particles in the organic solvent. As for the above reaction product coating each surface of the above inorganic particles, examples of the reaction product obtained by reacting the compound represented by “Formula (I)” with at least one compound described above include a compound represented by “Formula (II)” shown in the following:

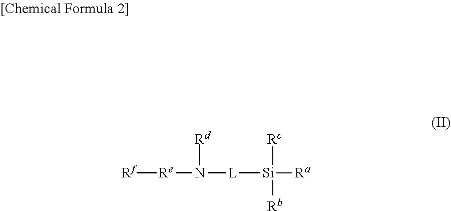

(wherein “R^{a}”, “R^{b}”, and “R^{c}” are each independently a hydrogen atom, a hydroxyl group, an alkyl group, an alkenyl group, an alkynyl group, an alkoxy group, an alkenyloxy group, or an alkynyloxy group; “R^{d}” is a hydrogen atom, an alkyl group, an alkenyl group, an alkynyl group, a cycloalkyl group, a cycloalkenyl group, a cycloalkynyl group, or a heterocyclic group; “N—R^{e}” is at least one bond selected from the group consisting of an amide bond, a sulfonamide bond, a urethane bond, and a urea bond; “R^{e}” is an alkyl group, an alkenyl group, an alkynyl group, a cycloalkyl group, a cycloalkenyl group, a cycloalkynyl group, an aralkyl group, or an aryl group; and “L” is an alkylene group, an alkynylene group, an alkenylene group, or an alkyleneaminoalkylene group.)

As for the alkyl moiety, alkenyl moiety, and alkynyl moiety in “Formula (II)”, for example, those described in the description of the compound of “Formula (I)” above can be used. The cycloalkyl group in “Formula (II)” is desirably a group having 3 to 30 carbon atoms, and is more desirably a group having 3 to 6 carbon atoms, such as cyclopropyl, cyclobutyl, cyclopentyl, or cyclohexyl. The cycloalkenyl group in “Formula (II)” is desirably a cycloalkenyl group having 3 to 30 carbon atoms, and is more desirably a cycloalkenyl group having 3 to 6 carbon atoms. The cycloalkynyl group in “Formula (II)” is desirably a cycloalkynyl group having 3 to 30 carbon atoms, and is more desirably a cycloalkynyl group having 3 to 6 carbon atoms.

The heterocyclic group in “Formula (II)” is desirably a 3- to 30-membered saturated cyclic group or unsaturated cyclic group, and may be a monocyclic heterocyclic group or a polycyclic heterocyclic group. Among these, a 5-membered monocyclic heterocyclic group or a 6-membered monocyclic heterocyclic group is further desirable. Desirable examples of the 5-membered monocyclic heterocyclic group include the following groups: thienyl groups such as 2-thienyl and 3-thienyl; furyl groups such as 2-furyl and 3-furyl; pyrrolyl groups such as 2-pyrrolyl and 3-pyrrolyl; oxazolyl groups such as 2-oxazolyl, 4-oxazolyl, and 5-oxazolyl; isoxazolyl groups such as 3-isoxazolyl, 4-isoxazolyl, and 5-isoxazolyl; thiazolyl groups such as 2-thiazolyl, 4-thiazolyl, and 5-thiazolyl; isothiazolyl groups such as 3-isothiazolyl, 4-isothiazolyl, and 5-isothiazolyl; pyrazolyl groups such as 3-pyrazolyl, 4-pyrazolyl, and 5-pyrazolyl; and imidazolyl groups such as 2-imidazolyl, 4-imidazolyl, and 5-imidazolyl. Desirable examples of the 6-membered monocyclic heterocyclic group include the following groups: pyridyl groups such as 2-pyridyl, 3-pyridyl, and 4-pyridyl; pyrimidyl groups such as 2-pyrimidyl, 4-pyrimidyl, and 5-pyrimidyl; pyrazinyl groups such as 2-pyrazinyl and 3-pyrazinyl; pyridazinyl groups such as 3-pyridazinyl and 4-pyridazinyl; 1,3,5-triazinyl groups such as 2-(1,3,5-triazinyl); and 1,2,4-triazinyl groups such as 3-(1,2,4-triazinyl), 5-(1,2,4-triazinyl), and 6-(1,2,4-triazinyl). The aryl moiety in the aralkyl group or aryl group in “Formula (II)” is desirably a group having 7 to 30 carbon atoms, and is more desirably a group having 6 to 10 carbon atoms such as phenyl and naphthyl.

When the inorganic particles manufactured in step (B) above are mixed with at least one compound selected from the group consisting of a carboxylic acid, a carboxylic acid halide, an acid anhydride, a sulfonic acid halide, and an isocyanate, this compound reacts with a silicate compound having an amino group and/or a hydrolysis product of the silicate compound coating each surface of the inorganic particles, and the reaction product produced thereby comes to coat each surface of inorganic particles. The silicate compound having an amino group and/or a hydrolysis product thereof, which coats each surface of the inorganic particles, binds with the above compound, whereby a silicate compound having an alkyl chain having a large number of carbon atoms is synthesized on each surface of the inorganic particles. This reaction product preferably has at least one bond selected from the group consisting of an amide bond, a sulfonamide bond, a urethane bond, and a urea bond.

Examples of the compound to be reacted include at least one compound selected from the group consisting of a carboxylic acid, a carboxylic acid halide, an acid anhydride, a sulfonic acid halide, and an isocyanate, and a carboxylic acid halide is more preferred.

Examples of the carboxylic acid include acetic acid, propionic acid, maleic acid, and phthalic acid. Examples of the carboxylic acid halide include acetic acid chloride, acetic acid bromide, propionic acid chloride, decanoyl chloride (decanoic acid chloride), 10-undecenoyl chloride (10-undecenoic acid chloride), and methacryloyl chloride (methacrylic acid chloride). Examples of the acid anhydride include acetic anhydride, and also include dicarboxylic acid anhydrides such as maleic anhydride, phthalic anhydride, tetrahydrophthalic anhydride, hexahydrophthalic anhydride, methyl-substituted tetrahydrophthalic anhydride, methyl-substituted hexahydrophthalic anhydride, 3,6-endomethylenetetrahydrophthalic anhydride, and methyl-substituted 3,6-endomethylenetetrahydrophthalic anhydride. Examples of the sulfonic acid halide include 4-toluenesulfonic acid chloride, ethanesulfonic acid chloride, and 1-octanesulfonic acid chloride. Examples of the isocyanate include methyl isocyanate, toluene diisocyanate, diphenylmethane diisocyanate, hexamethylene diisocyanate, 2,2,4-trimethylhexamethylene diisocyanate, 2,4,4-trimethylhexamethylene diisocyanate, p-phenylene diisocyanate-4,4′-dicyclohexylmethane diisocyanate, 3,3′-dimethyldiphenyl-4,4′-diisocyanate, dianisidine diisocyanate, m-xylene diisocyanate, isophorone diisocyanate, 1,5-naphthalene diisocyanate, trans-1,4-cyclohexyl diisocyanate, lysine diisocyanate, dimethyltriphenylmethane tetraisocyanate, triphenylmethane triisocyanate, and tris(isocyanatophenyl) thiophosphate.

The compounding ratio between the amino group and the compound in the above reaction can appropriately be set, and the case where a molar ratio of the amino group (specifically, amount in terms of “—NH₂”)/the compound is 0.1 or more is preferred because a predetermined amount of the reaction product is obtained. The molar ratio is more preferably 0.5 or more, and still more preferably 0.8 or more. Meanwhile, a molar ratio of the amino group (amount in terms of —NH₂)/the compound of 2.0 or less is preferred because an excess aminating agent hardly remains. The molar ratio is more preferably 1.8 or less, and still more preferably 1.5 or less. Conditions such as the reaction temperature and reaction time can appropriately be set, and a temperature of 10 to 100° C. is preferred, and a temperature of 20 to 50° C. is more preferred.

In this step, addition of a basic compound is preferred because a product such as hydrochloric acid produced during the reaction is neutralized. Also, when the above polymer dispersing agent is mixed in this step, the reaction can be performed while dispersing the inorganic particles. Instead of the above polymer dispersing agent, an organic amine such as triethylamine may be used. Furthermore, when using the above polymer dispersing agent having a basic functional group, the dispersion of the inorganic particles and neutralization of the product can be performed. In this way, each surface of the inorganic particles is coated with the reaction product, whereby the surface-coated inorganic particles can be manufactured. In addition, since the surface-coated inorganic particles obtained thereby are dispersed in the organic solvent, the surface-coated inorganic particles in this state can also be used as a dispersion. Furthermore, in this organic solvent dispersion, the surface-coated inorganic particles may be more dispersed using a suspending machine or a dispersing machine. The content of the inorganic particles can appropriately be set.

(D) The organic solvent in which the above surface-coated inorganic particles are suspended is subjected to solid-liquid separation to recover the surface-coated inorganic particles.

As for the solid-liquid separation, a conventionally known method can be used, and the surface-coated inorganic particles are recovered using a method such as centrifugation, filtration, or ultrafiltration. A poor solvent may be mixed with the organic solvent in which the surface-coated inorganic particles are suspended to aggregate and precipitate the surface-coated inorganic particles, so that solid-liquid separation is facilitated. The poor solvent can appropriately be selected, and a polar solvent such as an alcohol or a nonpolar solvent such as hexane or petroleum ether may be used. The addition amount of the poor solvent can appropriately be set within the range that the surface-coated inorganic particles can be aggregated. The aggregated surface-coated inorganic particles can be separated from the organic solvent and the alcohol by solid-liquid separation, and the excessive compound can be removed. The surface-coated inorganic particles may be washed and dried as necessary. The drying temperature and the drying time can appropriately be set.

(E) The recovered inorganic particles are mixed with an organic solvent and dispersed in the organic solvent.

After steps (A) to (D) above, the surface-coated inorganic particles separated by solid-liquid separation (including the inorganic particles dried after solid-liquid separation) are suspended or dispersed in an organic solvent, whereby an organic solvent dispersion can be manufactured. As for the organic solvent, those described above can be used, and as a means for performing a suspension or dispersion, a known suspending machine or dispersing machine can be used. Mixing the polymer dispersing agent when dispersing the surface-coated inorganic particles in the organic solvent is preferred because the surface-coated inorganic particles can sufficiently be dispersed. As for the polymer dispersing agent, it is more preferred to use the above polymer dispersing agent having a basic functional group, and a polymer dispersing agent having an acidic functional group may be used.

The organic solvent dispersion or the paint composition containing the surface-coated inorganic particles, manufactured in such a way can be applied or sprayed on a substrate to manufacture a surface-coated inorganic particle layer. The substrate is not particularly limited, and glass, plastic, ceramic, metal, or the like can be used. A layer of the surface-coated inorganic particles can be formed on the substrate and cured as necessary. The layer can be appropriately cured by a conventional method, and drying at a temperature of 50 to 200° C. is preferred, and drying at a temperature of 80 to 150° C. is more preferred. The curing time can appropriately be set. The film thickness and the like can appropriately be set.

### EXAMPLES

Examples are as shown below, but the present invention is not limited to these examples.

### Example 1

An aqueous solution was obtained by mixing 0.48 g of 3-aminopropyltrimethoxysilane (manufactured by Shin-Etsu Chemical Co., Ltd.: KBM-903), 29.76 g of ion-exchanged water, and 0.16 g of acetic acid, and 1.6 g of titanium oxide (manufactured by ISHIHARA SANGYO KAISHA, LTD.: TTO-51A) and 98 g of 0.05 mm zirconia beads were added to the aqueous solution and dispersed with a bead mill. The beads were removed, and then centrifugation was performed to collect the supernatant, thereby obtaining an aqueous titanium oxide suspension (i.e., TiO₂ concentration: 5%) treated with 3-aminopropyltrimethoxysilane.

Next, 3.76 g of dioctyl sodium sulfosuccinate (manufactured by Sigma-Aldrich Japan K.K.: hereinafter referred to as DSS) was added to 80 g of the obtained aqueous suspension, and the resulting mixture was stirred at room temperature for 16 hours. After completion of the stirring, a precipitate was recovered by centrifugation and dried by heating at 150° C. for 2 hours. After drying, methyl ethyl ketone (hereinafter referred to as MEK) was added to the solid content, and the mixture was irradiated with ultrasonic waves for 10 minutes to obtain a MEK dispersion of titanium oxide (i.e., TiO₂ concentration: 5%) treated with 3-aminopropyltrimethoxysilane.

Next, 0.16 g of decanoyl chloride (manufactured by Tokyo Chemical Industry Co., Ltd.) was added to 10 g of the resulting MEK dispersion, and 2.13 g of a polymer dispersing agent (manufactured by Lubrizol Japan Limited: Solspers (registered trademark) 20000) was added thereto with stirring, and then the mixture was stirred at room temperature for 16 hours. After completion of the stirring, 10 g of methanol was added, and a precipitate was recovered by centrifugation. MEK was added to and dispersed in the precipitate to obtain a MEK dispersion 1.

### Example 2

The same operations as those in Example 1 were performed except that 0.17 g of 10-undecenoyl chloride was used in place of decanoyl chloride in Example 1 to obtain a MEK dispersion 2.

### Example 3

The same operations as those in Example 1 were performed except that 0.09 g of methacryloyl chloride was used in place of decanoyl chloride in Example 1 to obtain a MEK dispersion 3.

### Example 4

The same operations as those in Example 1 were performed except that methyl isobutyl ketone (hereinafter referred to as MIBK) was used in place of MEK in Example 1 to obtain a MIBK dispersion 1.

### Comparative Example 1

A solution was obtained by mixing 0.32 g of 3-aminopropyltrimethoxysilane 22.4 g (manufactured by Shin-Etsu Chemical Co., Ltd.: KBM-903), 29.92 g of MEK, and 0.16 g of a polymer dispersing agent (manufactured by Lubrizol Japan Limited: Solspers (registered trademark) 20000), and 1.6 g of titanium oxide (manufactured by ISHIHARA SANGYO KAISHA, LTD.: TTO-51A) and 98 g of 0.05 mm zirconia beads were added to the mixed solution and dispersed with a bead mill. The beads were removed, and then centrifugation was performed to collect the supernatant, but the whole amount of titanium oxide was precipitated.

### Reference Example 1

The aqueous titanium oxide dispersion (i.e., TiO₂ concentration: 5%) treated with 3-aminopropyltrimethoxysilane and prepared in Example 1 was used as a sample.

In Examples 1 to 4 and Reference Example 1, the particle size distribution and the transmittance were measured, and the mass of organic substances contained in the sample was further measured.

[Measurement of Particle Size Distribution]

The particle size distribution of the inorganic particles in the dispersion was measured using a dynamic light scattering (DLS) particle size distribution analyzer (Nanotrac (registered trademark) Wave 2 UZ152 manufactured by MicrotracBEL Corp.), and cumulative particle size distributions D10, D50, and D90 were measured. The results are shown in Table 1.

[Measurement of Transmittance]

Using a spectrophotometer (manufactured by Hitachi High-Tech Science Corporation: U-3010, quartz cell, thickness: 1 mm), the concentration of the inorganic particles in the dispersion was adjusted to 1.2%, and the transmittance of the dispersion was measured. For the measurement wavelength, a wavelength of 420 nm and a wavelength in the visible light region were used. As for visible light, the transmittance is represented by average transmittance.

[Measurement of Organic Substance Content]

The amount of the organic substance coating each surface of the inorganic particles was calculated from the difference between the dry weight at 120° C. and the weight after heating at 800° C. (i.e., loss on drying).

TABLE 1

| | | | | Transmittance (%) | | Organic |
|---|---|---|---|---|---|---|
| Experi- | Particle size distribution | | | | Visible light | Substance |
| mental | after washing (nm) | | | 420 | (average | content |
| Examples | D10 | D50 | D90 | nm | transmittance) | (%) |
| Example 1 | 11.3 | 19.4 | 34.9 | 68.6 | 87.6 | 20.8 |
| Example 2 | 11.7 | 18.1 | 40.8 | 59.1 | 84.0 | 22.7 |
| Example 3 | 13.2 | 21.5 | 36.4 | 71.8 | 89.4 | 18.4 |
| Example 4 | 15.8 | 25.1 | 39.0 | 61.7 | 84.4 | 22.0 |
| Reference | 19.0 | 27.7 | 41.0 | 61.5 | 83.7 | 13.0 |
| Example 1 | | | | | | |

It has been found that in the dispersions of Examples 1 to 4, the values of particle size distributions D10, D50, and D90 are almost comparable to the numerical values of the aqueous dispersion of Reference Example 1, and that the particles are sufficiently dispersed. In addition, as for the transmittance, as compared with the aqueous dispersion of Reference Example 1, it has been found that the dispersions of all the examples have a visible light transmittance equal to or higher than the value of the aqueous dispersion of Reference Example 1, and also have a transmittance at the measurement wavelength of 420 nm comparable to or higher than the value of the aqueous dispersion of Reference Example 1. Therefore, the dispersions of all the examples had sufficiently high transmittances.

### INDUSTRIAL APPLICABILITY

The present invention relates to surface-coated inorganic particles coated with a reaction product of the following compounds: a silicate compound having an amino group and/or a hydrolysis product of the silicate compound; and at least one compound selected from the group consisting of a carboxylic acid, a carboxylic acid halide, an acid anhydride, a sulfonic acid halide, and an isocyanate. According to the surface-coated inorganic particles of the present invention, the dispersibility of inorganic particles in an organic solvent can be sufficiently improved, and a function or performance of the inorganic particles can thereby be sufficiently exhibited.

1. Surface-coated inorganic particles coated with a reaction product of following compounds: a silicate compound having an amino group and/or a hydrolysis product of the silicate compound; and at least one compound selected from the group consisting of a carboxylic acid, a carboxylic acid halide, an acid anhydride, a sulfonic acid halide, and an isocyanate, on each surface of the inorganic particles.

2. The surface-coated inorganic particles according to claim 1, wherein the reaction product is a silicate compound having at least one bond selected from the group consisting of an amide bond, a sulfonamide bond, a urethane bond, and a urea bond, and/or a hydrolysis product of the silicate compound.

3. The surface-coated inorganic particles according to claim 1, wherein the reaction product is a silicate compound having 3 to 100 carbon atoms and/or a hydrolysis product of the silicate compound.

4. The surface-coated inorganic particles according to claim 1, wherein the inorganic particles are composed of inorganic core particles and an inorganic compound coating each surface of the inorganic core particles.

5. The surface-coated inorganic particles according to claim 1, wherein the inorganic particles or when the inorganic particles are composed of inorganic core particles and an inorganic compound coating each surface of the inorganic core particles, the inorganic core particles are titanium oxide particles.

6. A surface-coated inorganic particle-containing organic solvent dispersion comprising the surface-coated inorganic particles according to claim 1, which are dispersed in an organic solvent.

7. The surface-coated inorganic particle-containing organic solvent dispersion according to claim 6, further comprising a polymer dispersing agent.

8. A paint composition comprising:
the surface-coated inorganic particles according to claim 1;
an organic solvent; and
a resin.

9. A paint composition comprising:
the surface-coated inorganic particle-containing organic solvent dispersion according to claim 6; and
a resin.

10. A method for manufacturing surface-coated inorganic particles, the method comprising the steps of:
mixing, in an aqueous solvent, inorganic particles with a silicate compound having an amino group and/or a hydrolysis product of the silicate compound, thereby coating each surface of the inorganic particles with the silicate compound having an amino group and/or a hydrolysis product of the silicate compound; and
subsequently suspending, in an organic solvent, the inorganic particles coated with the silicate compound having an amino group and/or a hydrolysis product of the silicate compound, and then mixing therewith at least one compound selected from the group consisting of a carboxylic acid, a carboxylic acid halide, an acid anhydride, a sulfonic acid halide, and an isocyanate, thereby coating each surface of the inorganic particles with a reaction product of the silicate compound having an amino group and/or a hydrolysis product of the silicate compound and the at least one compound.

11. A method for manufacturing surface-coated inorganic particles, the method comprising the steps of:
performing the step as set forth in claim 10 of coating each surface of the inorganic particles with the silicate compound having an amino group and/or a hydrolysis product of the silicate compound, thereby obtaining an aqueous suspension containing the inorganic particles coated with the silicate compound having an amino group and/or a hydrolysis product of the silicate compound;
subsequently mixing the aqueous suspension with a surfactant, thereby transferring to an organic solvent the inorganic particles coated with the silicate compound having an amino group and/or a hydrolysis product of the silicate compound; and
subsequently mixing the inorganic particles transferred to the organic solvent with at least one compound selected from the group consisting of a carboxylic acid, a carboxylic acid halide, an acid anhydride, a sulfonic acid halide, and an isocyanate, thereby coating each surface of the inorganic particles with a reaction product of the silicate compound having an amino group and/or a hydrolysis product of the silicate compound and the at least one compound.

12. A method for manufacturing surface-coated inorganic particles, the method comprising the steps of:
performing the step as set forth in claim 11 of mixing the aqueous suspension with a surfactant, thereby transferring to an organic solvent the inorganic particles coated with the silicate compound having an amino group and/or a hydrolysis product of the silicate compound;
subsequently subjecting the inorganic particles transferred to the organic solvent to a heat treatment at a temperature of 80 to 200° C.; and
subsequently mixing the inorganic particles subjected to the heat treatment with at least one compound selected from the group consisting of a carboxylic acid, a carboxylic acid halide, an acid anhydride, a sulfonic acid halide, and an isocyanate, thereby coating each surface of the inorganic particles with a reaction product of the silicate compound having an amino group and/or a hydrolysis product of the silicate compound and the at least one compound.

13. A method for manufacturing surface-coated inorganic particles, the method comprising the step of:
performing the step as set forth in claim 10 of coating each surface of the inorganic particles with a reaction product of the silicate compound having an amino group and/or a hydrolysis product of the silicate compound and the at least one compound, thereby obtaining an organic solvent in which the surface-coated inorganic particles are suspended; and
subsequently subjecting the organic solvent to solid-liquid separation, thereby recovering the surface-coated inorganic particles.

14. A method for manufacturing a surface-coated inorganic particle-containing organic solvent dispersion, the method comprising the step of:
performing the step as set forth in claim 13 of recovering the surface-coated inorganic particles, thereby recovering the surface-coated inorganic particles; and subsequently dispersing the recovered surface-coated inorganic particles in an organic solvent.

15. A method for manufacturing a surface-coated inorganic particle layer, the method comprising:
applying or spraying on a substrate the surface-coated inorganic particle-containing organic solvent dispersion according to claim 6.

16. A method for manufacturing a surface-coated inorganic particle layer, the method comprising:
applying or spraying on a substrate the paint composition according to claim 8.
